(19) United States
(12) Patent Application Publication
(10) Pub. No.: US 2014/0017057 A1
(43) Pub. Date: Jan. 16, 2014

(54) DEVICE FOR FORMING AND PASSING ON STACKS OF BLISTER PACKS

(71) Applicant: Uhlmann Pac-Systeme GmbH & Co. KG, Laupheim (DE)

(72) Inventors: Bernd HAEHNEL, Stutensee (DE); Joachim HUCHLER, Gutenzell (DE)

(21) Appl. No.: 13/934,387

(22) Filed: Jul. 3, 2013

(30) Foreign Application Priority Data
Jul. 10, 2012 (EP) EP 12175745.4

(51) Int. Cl. B65G 57/03

(52) U.S. Cl. CPC B65G 57/03
USPC 414/790

(57) ABSTRACT

The device for forming and passing on stacks of blister packs comprises three drive units and three endless transfer units. Each transfer unit can be actuated by one of the drive units independently of the others. Each transfer unit comprises at least one conveyor belt on which two carrier elements are mounted rotatably and with an offset to each other. Each carrier element is positively guided in such a way that it is oriented horizontally at least when in a transfer area between a blister pack receiving position and a blister pack discharge position located underneath the blister pack receiving position. The drive units are actuated in such a way that two carrier elements of two different transfer units in each case move at a predetermined distance apart from the blister pack receiving position to the blister pack discharge position.

### RELATED APPLICATIONS

The present patent document claims the benefit of priority to European Patent Application No. EP 12175745.4, filed Jul. 10, 2012, the entire contents of each of which are incorporated herein by reference.

### FIELD AND BACKGROUND OF THE INVENTION

The present invention relates to a device for forming and passing on stacks of blister packs.

At the interface between the blister pack manufacturing machine and the cartoning machine of a pharmaceutical production line, there is often the task of collecting and grouping the stamped blister packs by means of a suitable device and of passing on the collected blister packs to the transport system which carries the blister packs to the cartoning machine. There are several ways in which this can be done.

The known devices for forming and passing on stacks of blister packs, however, usually take up a considerable amount of space. In addition, the blister packs are usually allowed to fall freely on their own, so that, depending on the height of the stack of blister packs, the output of the device is also limited by the acceleration due to gravity. In addition, blister packs can turn as they fall or bounce back up when they land, which is also disadvantageous with respect to the reliable operation of the device.

### SUMMARY OF THE INVENTION

It is an object of the present invention to provide a device for forming and passing on stacks of blister packs which is sturdy and requires only a modest amount of space, and in which the individual blister packs are conveyed reliably from a blister pack receiving position to a blister pack discharge position.

According to an aspect of the invention, the device for forming and passing on stacks of blister packs comprises three independent drive units and three endless transfer units, wherein each of the three transfer units can be actuated independently of the others by one of the three drive units. Each transfer unit comprises at least one conveyor belt, on each of which two carrier elements are mounted with an offset from each other and with the freedom to rotate. Each carrier element is positively guided in such a way that it is oriented horizontally at least when in a transfer area between a blister pack receiving position and a blister pack discharge position located underneath the blister pack receiving position. The drive units are actuated in such a way that two carrier elements of two different transfer units move from the blister pack receiving position to the blister pack discharge position while remaining a predetermined distance apart, as a result of which they keep the stack of blister packs clamped between them from the top and bottom while in the transfer area.

This design makes it possible to minimize the amount of space which the device occupies, wherein at the same time the reliable operation of the blister pack transfer system is guaranteed.

Each transfer unit preferably comprises two conveyor belts, which are arranged parallel to each other and a certain distance apart. In this way, the carrier elements can be arranged symmetrically between the two conveyor belts of each transfer unit, which contributes to the uniform and reliable operation of the device.

Each carrier element is preferably designed as a comb. This offers the advantage that, if the cell brackets in the area of the product transport system of the cartoning machine, i.e., in the blister pack discharge position, are also designed as combs, the comb-like carrier elements can pass through the comb-like cell brackets even while the system for transporting the goods to be packaged is operating continuously.

Each carrier element preferably comprises, at a first end, a horizontal rod, which is supported rotatably in a receptacle element mounted on the corresponding conveyor belt. In this way, the carrier elements can be easily mounted with freedom to rotate on the conveyor belt.

The rod is preferably connected to an angled guide lever, which comprises a cam roller on each of its two arms. These rollers are guided in two guide grooves in a support plate of the device. With this simple form of positive guidance, it is possible to keep the carrier elements horizontal in the transfer area between the blister pack receiving position and the blister pack discharge position and simultaneously to reduce to a minimum the space required for the carrier elements during the rest of their round trip.

The conveyor belts of each transfer unit are preferably parallel to each other and travel around a substantially rectangular course, wherein a deflecting pulley for each conveyor belt is installed at each corner of the rectangle. With this design, the guide grooves in the support plates can have a very simple layout, resulting in a highly compact construction.

In a preferred embodiment, the conveyor belt is designed as a toothed belt, and the deflecting pulleys are designed as toothed belt pulleys.

It is preferable for only one of the deflecting pulleys for each conveyor belt to be driven by the associated drive unit, whereas the other deflecting pulleys are simply carried along.

The drive units are preferably designed as servo motors so that the individual transfer units can be actuated with precision.

An important advantage of having three different transfer units is that the three drive units can be actuated preferably in such a way that, while two carrier elements of two different transfer units are moving a certain distance apart from the blister pack receiving position to the blister pack discharge position, one carrier element of the remaining, i.e., third, transfer unit is moving into the blister pack receiving position. In this way, new blister packs can be deposited on the carrier element of the third transfer unit while one stack of blister packs is still being transferred from the blister pack receiving position to the blister pack discharge position, as a result of which the output of the overall device is increased, continuous operation is guaranteed, and it is also possible to compensate for vacancies in the blister pack feed.

### BRIEF DESCRIPTION OF THE DRAWINGS

Additional features and advantages of the present invention can be derived from the following description, which refers to the drawings.

FIG. 1 is a schematic perspective view, from a first side, of one embodiment of the device for forming and passing on stacks of blister packs according to the invention;

FIG. 2 is a schematic perspective view, from a second side, of the device for forming and passing on stacks of blister packs according to FIG. 1;

FIG. 3 is a schematic perspective view of the internal components of the device for forming and passing on stacks of blister packs according to FIG. 1; and

FIGS. 4-7 are side views of the sequence of steps involved in the formation and passing-on of stacks of blister packs with the device of FIG. 1.

### DETAILED DESCRIPTION OF SPECIFIC EMBODIMENTS

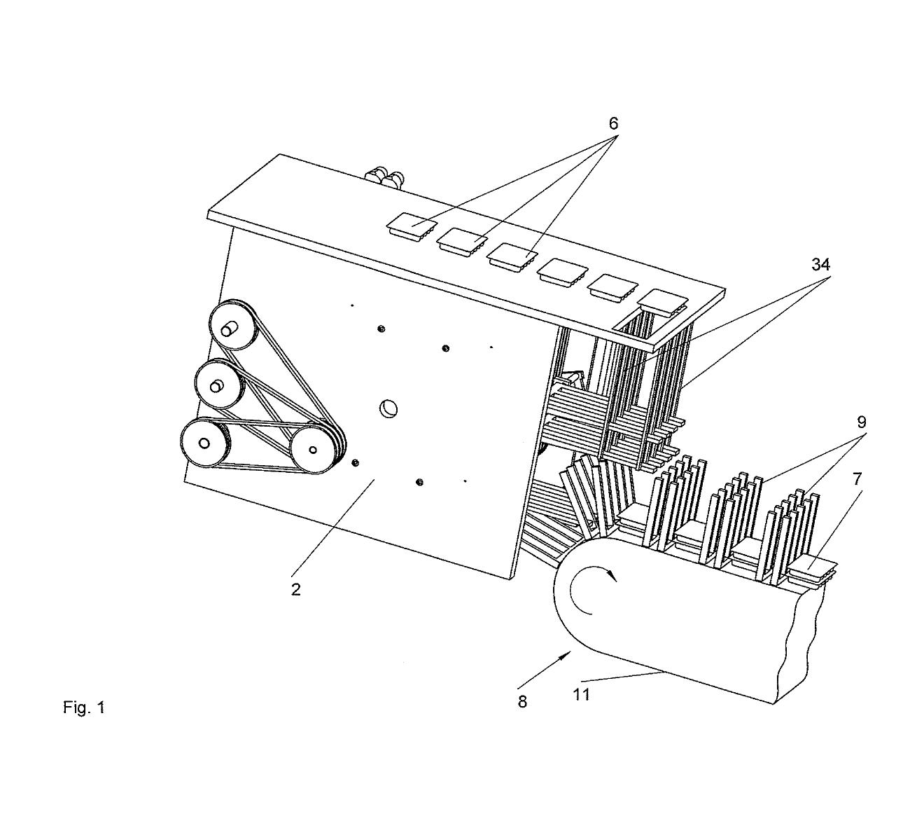

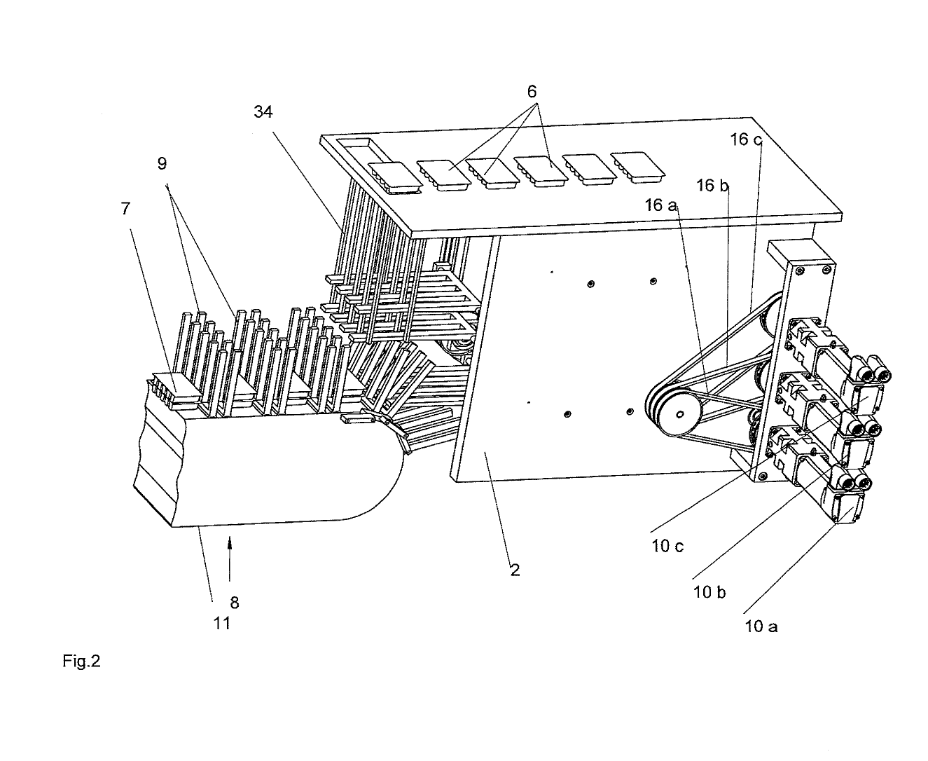

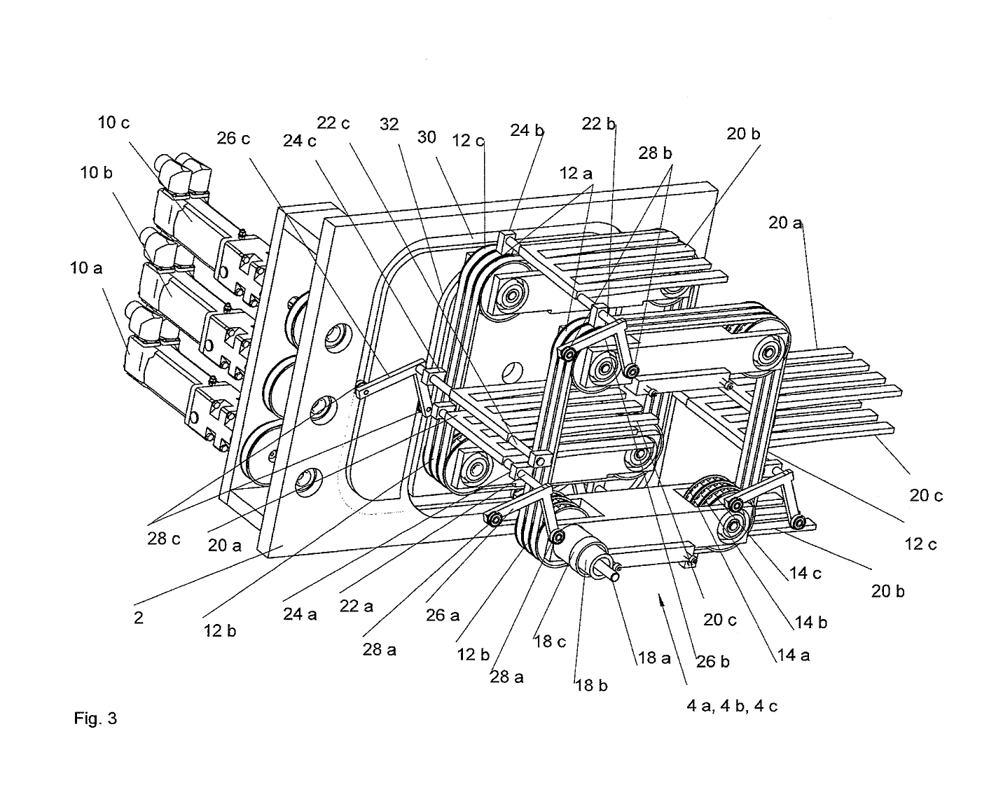

The device for forming and passing on stacks of blister packs illustrated in FIGS. 1 and 2 comprises two support plates 2, which form between them an intermediate space, in which three endless traveling transfer units 4a, 4b, 4c are arranged (as shown in FIG. 3). The transfer units 4a, 4b, 4c accept blister packs 6, which are conveyed to them by a feed device (not shown), and pass on the stacks 7 of these blister packs, formed by stacking the packs on top of each other, to a transport device 8, which conveys the stacks 7 of blister packs onward for further processing. The blister packs 6 are supplied by the feed device (not shown) preferably from above to the device for forming and passing on stacks of blister packs, this usually being done individually and at predetermined time intervals. Such feed devices are generally known. For example, suction belts can be used, from which the blister packs 6 are suspended as they are being transported. Other types of feed devices which pass on the stamped blister packs 6 produced in a blister pack manufacturing machine to the device for forming and passing on stacks of blister packs are also possible. The transport device 8 for conveying the formed stacks 7 downstream from the device for forming and passing on stacks of blister packs, however, is usually an endless product transport chain of a cartoning machine, in which the formed stacks 7 of blister packs are pushed into corresponding drop shafts. The transport device 8 comprises several carrier units 9, also called cell brackets, which define the individual compartments of the transport device 8. These carrier units 9 are preferably designed as combs and project outward from an endless chain 11 or belt.

The device for forming and passing on stacks of blister packs comprises three independent drive units 10a, 10b, 10c, which actuate the three transfer units 4a, 4b, 4c independently of each other. In the concrete exemplary embodiment (see especially FIG. 3), each transfer unit 4a, 4b, 4c comprises two conveyor belts 12a, 12b, 12c, which are parallel to each other and a certain distance apart. In detail, the two inner conveyor belts 12a of transfer unit 4a are driven by the first drive unit 10a, whereas the two middle conveyor belts 12b of transfer unit 4b are driven by the second drive unit 10b; and the two outer conveyor belts 12c of transfer unit 4c are driven by the third drive unit 10c.

All of the conveyor belts 12a, 12b, 12c travel around a substantially rectangular course and extend parallel to each other. In each corner of the rounded rectangle formed by the conveyor belts 12a, 12b, 12c there is a deflecting pulley 14a, 14b, 14c for each of the conveyor belts 12a, 12b, 12c. In the preferred embodiment, only one of the deflecting rolls 14a, 14b, 14c for each of the conveyor belts 12a, 12b, 12c is driven by the associated drive unit 10a, 10b, 10c, whereas the three other deflecting pulleys 14a, 14b, 14c of the associated conveyor belt 12a, 12b, 12c are simply carried along by the belt. In the exemplary embodiment illustrated in FIG. 3, only the deflecting pulleys 14a, 14b, 14c in the left lower area of the rectangle are driven. In the preferred embodiment shown, the deflecting pulleys 14a, 14b, 14c are designed as toothed belt pulleys, and the conveyor belts 12a, 12b, 12c are designed as toothed belts.

In the example shown here, the force is transmitted from the drive units 10a, 10b, 10c to the deflecting pulleys 14a, 14b, 14c by way of transmission belts 16a, 16b, 16c and a corresponding arrangement of telescoping shafts 18a, 18b, 18c (FIG. 3) of the deflecting pulleys 14a, 14b, 14c. In the example shown, the shaft 18a for the two inner deflecting pulleys 14a is designed as a solid shaft, whereas the two other pairs of deflecting pulleys 14b, 14c are driven by way of two shafts 18b, 18c, which are designed as hollow shafts. All of the shafts 18a, 18b, 18c are free to rotate independently of each other. There are obviously many other possible ways in which the force can be transmitted from the drive units 10a, 10b, 10c to the transfer units 4a, 4b, 4c.

In addition to the two conveyor belts 12a, 12b, 12c, each transfer unit 4a, 4b, 4c, also comprises two carrier elements 20a, 20b, 20c, which are offset from each other and mounted rotatably on the associated conveyor belt 12a, 12b, 12c. More precisely, the two carrier elements 20a are mounted on the conveyor belt 12a, the two carrier elements 20b are mounted on the conveyor belt 12b, and the two carrier elements 20c are mounted on the conveyor belt 12c. In relationship to the endless travel of the associated transfer unit 4a, 4b, 4c, the two carrier elements 20a, 20b, 20c of each transfer unit 4a, 4b, 4c are preferably arranged exactly opposite each other, i.e., offset from each other by 180°.

The carrier elements 20a, 20b, 20c are preferably straight and flat in design and, in a preferred embodiment, are in the form of combs. In the embodiment shown here, each carrier element 20a, 20b, 20c comprises, at a first end, a horizontal rod 22a, 22b, 22c, each of which is supported rotatably in a receptacle element 24a, 24b, 24c mounted on the corresponding conveyor belt 12a, 12b, 12c. The receptacle elements 24a, 24b, 24c can be pins, for example, which project outward from the conveyor belt 12a, 12b, 12c and are provided with appropriate bearing bushes for the rods 22a, 22b, 22c.

Each rod 22a, 22b, 22c is connected to an angled guide lever 26a, 26b, 26c, which comprises two cam rollers 28a, 28b, 28c one on each of its two arms. The two cam rollers 28a, 28b, 28c of a guide lever are guided in two offset guide grooves 30, 32 in one of the support plates 2 of the device. The guide grooves 30, 32 preferably have the same pattern. The other support plate 2 comprises identical guide grooves 30, 32.

It is advantageous for successive carrier elements 20a, 20b, 20c of different transfer units 4a, 4b, 4c to have their guide levers 26a, 26b, 26c on different sides of the corresponding rod 22a, 22b, 22c and thus for the cam rollers 28a, 28b, 28c of successive carrier elements 20a, 20b, 20c to be guided alternately in the guide grooves 30, 32 of the one support plate and in those of the opposite support plate 2. As a result, even though the carrier elements 20a, 20b, 20c are close together, it is possible in this way to prevent the guide levers 26a, 26b, 26c and the cam rollers 28a, 28b, 28c from interfering with each other. The presence of precisely two carrier elements 20a, 20b, 20c per transfer unit 4a, 4b, 4c and the presence of altogether three transfer units 4a, 4b, 4c also creates the situation that the two carrier elements 20a, 20b, 20c of each transfer unit 4a, 4b, 4c have their guide levers 26a, 26b, 26c (and thus also the cam rollers 28a, 28b, 28c) on opposite sides in each case.

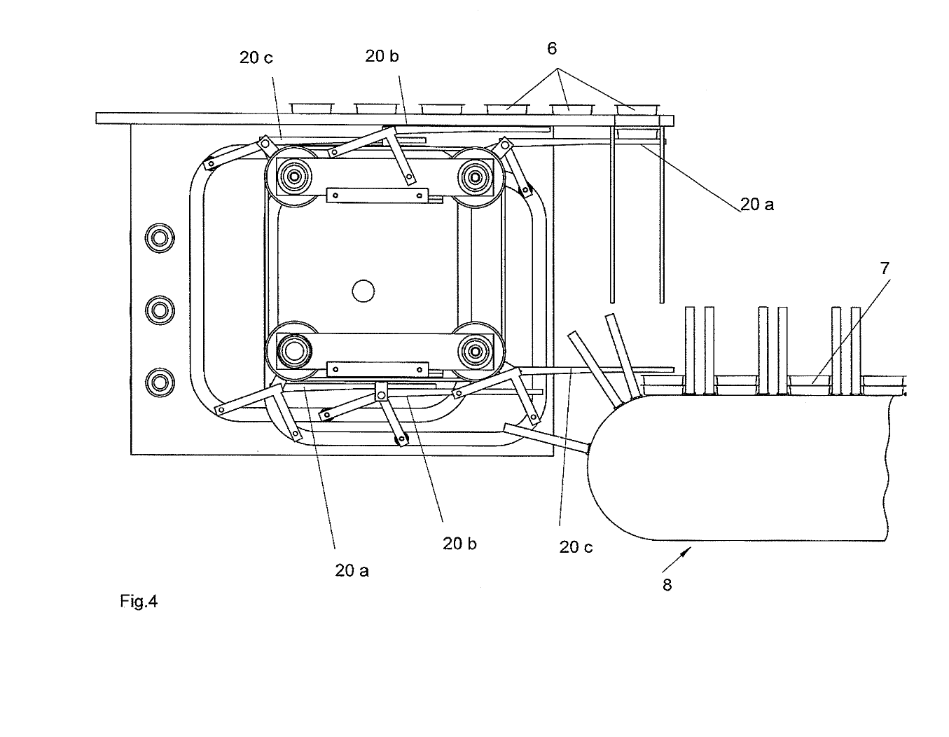

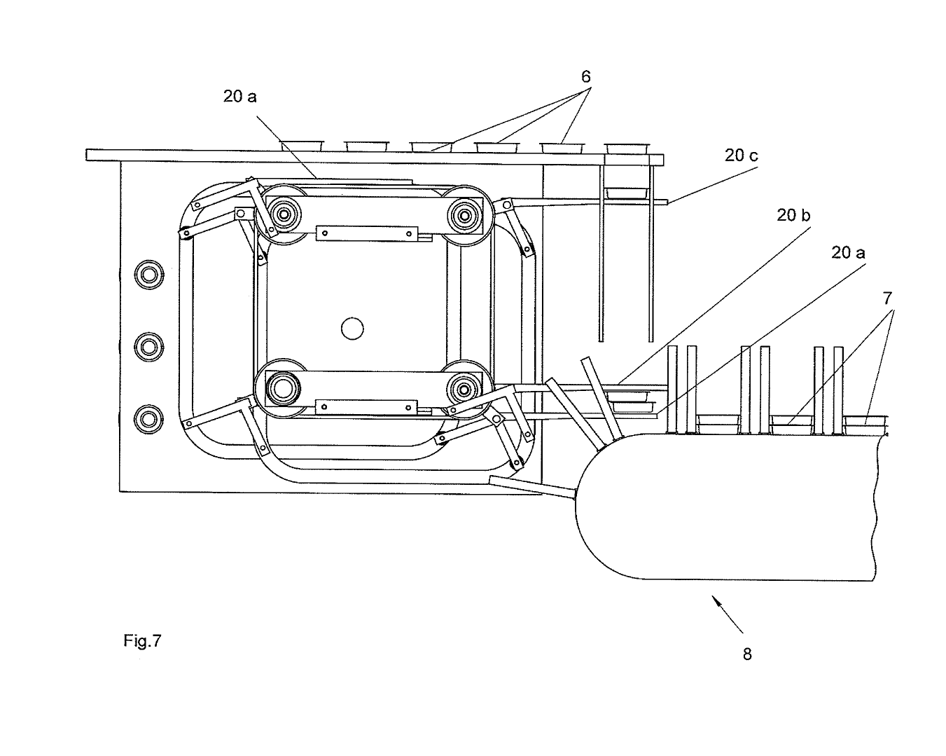

There are of course many other possible ways of suitably guiding the carrier elements 20a, 20b, 20c. The important point in all cases, however, is that each carrier element 20a, 20b, 20c is positively guided in such a way that it is oriented horizontally at least while it is in a transfer area between a blister pack receiving position (see the position of the carrier element 20a at the top right in FIG. 4) and a blister pack discharge position (see the position of the carrier element 20a at the bottom right in FIG. 7) located underneath the blister pack receiving position. The drive units 10a, 10b, 10c are actuated in such a way that two carrier elements 20a, 20b, 20c of two different transfer units 4a, 4b, 4c are always moving at a predetermined distance apart from the blister pack receiving position to the blister pack discharge position (preferably in the vertical direction only) and thus keep the stack 7 of blister packs clamped between them from the top and bottom in the transfer area. In other words, the two carrier elements 20a, 20b, 20c of the two different transfer units 4a, 4b, 4c form a bottom clamp and a top clamp for the stack of blister packs. The guidance of the stack 7 of blister packs in the transfer area can also be assisted by vertically arranged, stationary guide rods 34.

The three drive units 10a, 10b, 10c are actuated in such a way that, while the two carrier elements 20a, 20b, 20c of two different transfer units 4a, 4b, 4c are moving at a predetermined distance apart from the blister pack receiving position to the blister pack discharge position, one carrier element 20a, 20b, 20c of the remaining, i.e., third, transfer unit 4a, 4b, 4c is moving into the blister pack receiving position. In this way, new blister packs 6 can be stacked in the device while the preceding stack 7 is still being transferred.

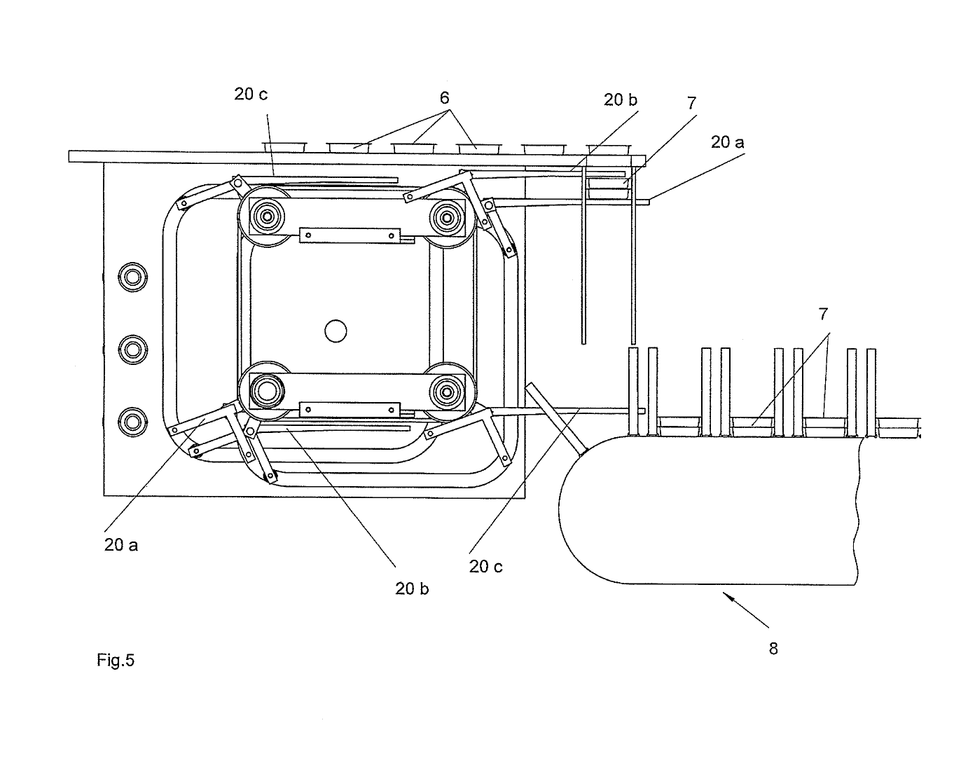

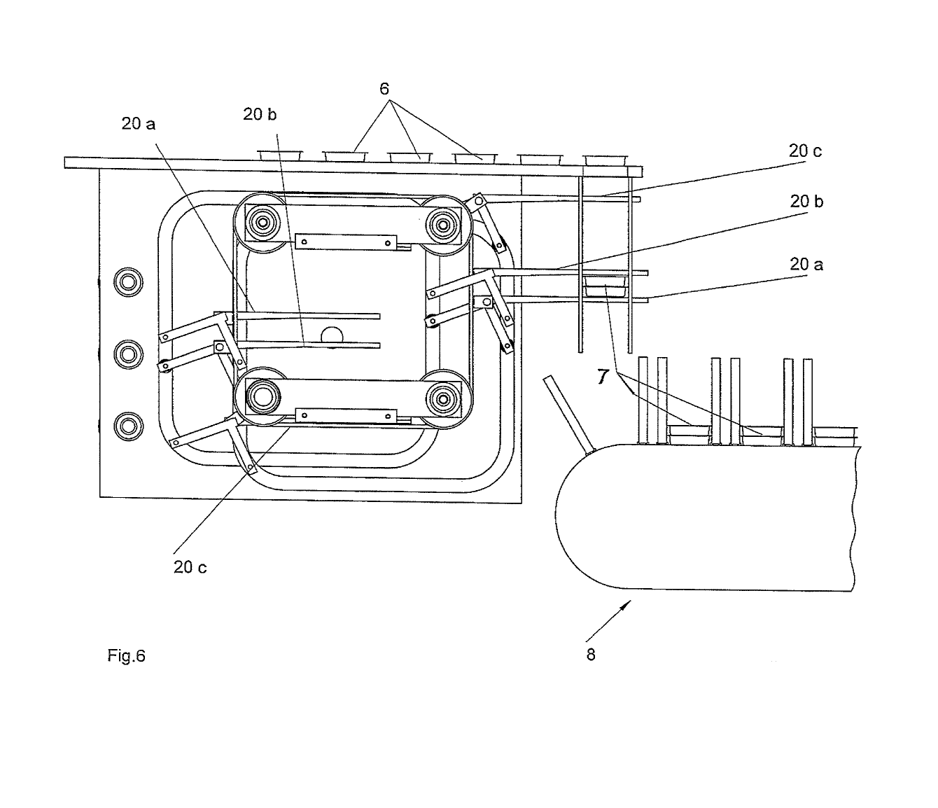

The way in which the device operates will now be explained in greater detail on the basis of FIGS. 4-7. In FIG. 4, the carrier element 20a at the top right starts out in the blister pack receiving position. In this position, it serves as a base for the blister packs 6 to be stacked, which are supplied from above by the feed device (not shown). Ideally, the carrier element 20a moves downward in steps as the stack 7 is being filled in order to ensure the stepwise filling of the device. If now, as shown in FIG. 5, a stack 7 of blister packs of the desired height has been formed on the carrier element 20a, the stack 7 is covered by the carrier element 20b at the top right, and the stack 7 is thus clamped between the two carrier elements 20a and 20b. In this position, the two carrier elements 20a, 20b are lowered (see FIG. 6), while the carrier element 20c of the third transfer unit 4c has already reached the blister pack receiving position at the top right again. While the stack 7 of blister packs is being held between the carrier elements 20a and 20b and before it is actually passed along to the transport device 8, the next stack 7 can already be formed on the carrier element 20c. Because the movements of the three transfer units 4a, 4b, 4c are controlled independently, it is therefore always possible to use two carrier elements 20a, 20b, 20c of two different transfer units 4a, 4b, 4c alternately, in different sequences, as a base element for a stack 7 of blister packs and as a cover element for a stack 7 and thus to create a circuit which guarantees continuous operation.

In addition to the exclusively vertical movement of the carrier elements 20a, 20b, 20c in the transfer area, other patterns of movement are also conceivable, depending on the geometry of the overall arrangement. Multi-track designs are also possible.

1. A device for forming stacks of blister packs at a blister pack receiving position and passing on the stacks of blister packs from the blister pack receiving position to a blister pack discharge position located underneath the blister pack receiving position, the device comprising:
three independent drive units; and
three endless transfer units, wherein each of the three transfer units can be actuated by one of the three drive units independently of the other transfer units;
wherein each transfer unit comprises at least one conveyor belt, on which two carrier elements are mounted with an offset to each other and with freedom to rotate;
wherein each carrier element is positively guided in such a way that it is oriented horizontally at least when in a transfer area between the blister pack receiving position and the blister pack discharge position; and
wherein the drive units are actuated in such a way that two carrier elements of two different transfer units in each case move at a predetermined distance apart in the transfer area from the blister pack receiving position to the blister pack discharge position, thereby keeping a stack of blister packs clamped between the two carrier elements of the two different transfer units, wherein the two carrier elements of the two different transfer units form a top clamp and a bottom clamp for the stack of blister packs.

2. The device of claim 1 wherein each transfer unit comprises two conveyor belts, which are parallel to each other and are a certain distance apart.

3. The device of claim 1 wherein each carrier element has the form of a comb.

4. The device of claim 1 wherein each carrier element comprises, at a first end, a horizontal rod, which is supported rotatably in a receptacle element mounted on the associated conveyor belt.

5. The device of claim 4 wherein the rod is connected to an angled guide lever having two arms, wherein a cam roller is arranged on each of the two arms, the two cam rollers being guided in guide grooves in a support plate of the device.

6. The device of claim 1 wherein the conveyor belts of each transfer unit are parallel to each other and travel around a course substantially in the form of a rectangle, and wherein a deflecting pulley for each conveyor belt is arranged in each corner of the rectangle.

7. The device of claim 6 wherein the conveyor belts are designed as toothed belts, and wherein the deflecting pulleys are designed as toothed belt pulleys.

8. The device of claim 1 wherein one of the deflecting pulleys for each of the conveyor belts is driven by the associated drive unit.

9. The device of claim 1 wherein the three drive units are servo motors.

10. The device of claim 1 wherein the three drive units are actuated in such a way that, while two carrier elements of two different transfer units are moving at a certain predetermined distance apart from the blister pack receiving position to the blister pack discharge position, one carrier element of the remaining third transfer unit is moving into the blister pack receiving position.
